(19) United States
(12) Patent Application Publication
(10) Pub. No.: US 2026/0080520 A1
(43) Pub. Date: Mar. 19, 2026

(54) REFERENCE-BASED INPAINTING USING CORRESPONDENCE GUIDANCE IN DIFFUSION MODELS

(71) Applicant: NVIDIA Corporation, Santa Clara, CA (US)

(72) Inventor: Min-Hung Chen, Zhubei City (TW)

(21) Appl. No.: 19/208,399

(22) Filed: May 14, 2025

Related U.S. Application Data
(60) Provisional application No. 63/696,251, filed on Sep. 18, 2024.

(51) Int. Cl. G06T 5/77; G06T 5/50; G06T 5/70; G06T 9/00

(52) U.S. Cl. CPC G06T 5/77; G06T 5/50; G06T 5/70; G06T 9/00; G06T 2207/20221

(57) ABSTRACT

Image inpainting aims to restore damaged regions of a target image. Because any plausible outcome could be considered valid for this task, reference-based image inpainting has been used in which a reference image (e.g. capturing substantially the same scene as the target image) guides the inpainting process, thereby increasing the probability that the target image is restored to its original state. However, current diffusion models used for image inpainting, even though conditioned on reference images, lack direct awareness of the relationships between the target and reference which results in a loss of faithfulness in the inpainted result. The present disclosure guide the inpainting process of a diffusion model with reference-target image correspondences as constraints, which can preserve the reference-target geometric relationships and thus enhance faithfulness of the inpainted target image to the reference image.

### CLAIM OF PRIORITY

This application claims the benefit of U.S. Provisional Application No. 63/696,251 (Attorney Docket No. NVIDP1416+/24-TP-1196US01) titled “ENHANCING FAITHFULNESS IN REFERENCE-BASED INPAINTING WITH CORRESPONDENCE GUIDANCE IN DIFFUSION MODELS,” filed Sep. 18, 2024, the entire contents of which is incorporated herein by reference.

### TECHNICAL FIELD

The present disclosure relates to inpainting as a computer vision task.

### BACKGROUND

Image inpainting aims to restore damaged regions of a target image. This task is inherently ill-posed, as any plausible outcome could be considered valid. Consequently, general image inpainting approaches are insufficient for faithfully recovering the original content of the images. To address this issue, reference-based image inpainting introduces supplementary images, known as reference images, to guide the recovery process for damaged regions. These reference images can be photographs of the same scene with the target image, taken from different viewpoints or at different time slots. With the guidance of reference images, it becomes more practical to restore the target image to its original state.

Denoising diffusion probabilistic models excel as generative models, producing high-quality and diverse images, and showing significant potential in reference-based inpainting. Existing diffusion-based methods for reference-based inpainting focus on training or fine-tuning an image-conditioned model to fill damaged regions based on reference images. However, they lack direct awareness of the relationships between targets and references, which is crucial for earlier approaches based on geometry matching. Without this awareness, diffusion models merely conditioned on reference images fail to ensure correct reference-target geometric correlation, leading to inpainting results that do not fully adhere to the content of the references, thus losing faithfulness. For example, diffusion models may include unwanted objects in their results which can lead to incorrect scene layouts and/or geometry.

There is a need for addressing these issues and/or other issues associated with the prior art. For example, there is a need to guide the inpainting process of a diffusion model with reference-target image correspondences as constraints, which can preserve the reference-target geometric relationships and thus enhance faithfulness of the inpainted target image to the reference image.

### SUMMARY

A method, computer readable medium, and system are disclosed to perform reference-based inpainting for a target image. An estimated correspondence between the target image and a reference image is iteratively refined, using a diffusion model, to generate a refined estimated correspondence. The diffusion model is guided with the refined estimated correspondence as a constraint to inpaint the target image based on the reference image.

### BRIEF DESCRIPTION OF THE DRAWINGS

FIG. 1 illustrates a flowchart of a method to provide reference-based inpainting for a target image, in accordance with an embodiment.

FIG. 2 illustrates a system to provide reference-based inpainting for a target image, in accordance with an embodiment.

FIG. 3 illustrates a method of the system of FIG. 2, in accordance with an embodiment.

FIG. 4 illustrates a method of a denoising step from the method of FIG. 3, in accordance with an embodiment.

FIG. 5 illustrates an inpainting method, in accordance with an embodiment.

FIG. 6 illustrates an exemplary input and output of the inpainting method of FIG. 5, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

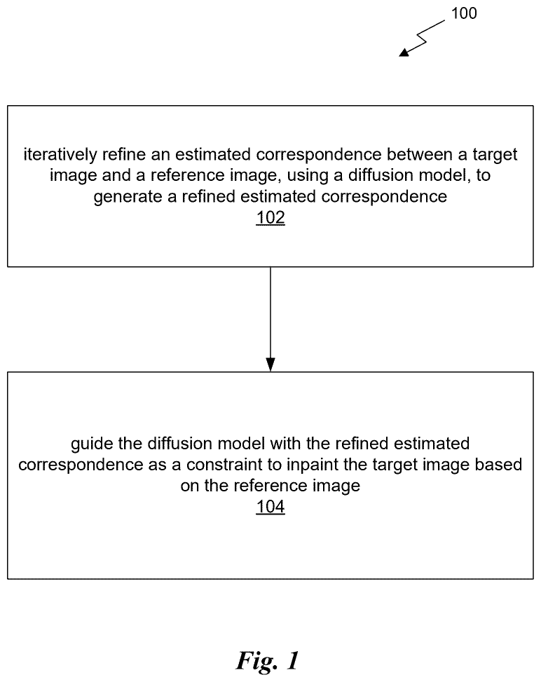

FIG. 1 illustrates a flowchart of a method 100 to provide a reference-based inpainting for a target image, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present description, the target image refers to a digital image on which inpainting is to be performed. In an embodiment, the target image may include at least one region (e.g. subset of pixels, etc.) to be inpainted. Inpainting refers to a computer process of generating pixel data for one or more regions of the target image, such as one or more damaged (e.g. blurry), faded, missing, etc. regions of the target image. Thus, inpainting may be performed to repair or restore one or more regions of the target image. In an embodiment, the target image may be input by a user for the purpose of inpainting the same.

As described below, the inpainting method 100 is performed at least in part by a diffusion model. The diffusion model refers to a machine learning model that can generate data from noise. The noise refers to (e.g. random or pseudo-random) artifacts that are present in the data. The noise may therefore present itself as the one or more regions of the target image to be inpainted, while the data may refer to the pixel data generated for (e.g. to repair) those one or more regions. The diffusion model may include a diffusion process that iteratively generates the data from the noise.

Returning to the method 100, in operation 102, an estimated correspondence between the target image and a reference image is iteratively refined, using a diffusion model, to generate a refined estimated correspondence. The reference image refers to a digital image that, at least in part, capture a same scene as the target image. In an embodiment, the target image and the reference image may capture different viewpoints of a same scene. In an embodiment, the reference image may be input by the user for use in guiding the inpainting of the target image.

Correspondence between the target image and the reference image refers to a determination of regions of the target and reference images that correspond to one another. For example, the correspondence may indicate regions of the target and reference images that depict same parts (e.g. geometries, objects, etc.) of a scene. In an embodiment, the estimated correspondence may map coordinates in the reference image to coordinates in the target image.

In the present method 100, an estimated correspondence may be generated, and is then iteratively refined using the diffusion model to result in a refined estimated correspondence. In an embodiment, the iterative refining may be initiated on an initial estimated correspondence. In an embodiment, the initial estimated correspondence may be generated by the diffusion model processing a latent tensor representative of the target image and the reference image to generate an initial attention map and computing the initial estimated correspondence from the initial attention map. In an embodiment, the latent tensor may be generated by stitching together the reference image and the target image to form a stitched image, encoding the stitched image to form an encoded stitched image, encoding a mask of the stitched image to form an encoded mask, encoding a noise tensor to form an encoded noise tensor, and concatenating the encoded stitched image, the encoded mask and the encoded noise tensor to form the latent tensor.

Iteratively refining the estimated correspondence refers to updating the estimated correspondence over one or more steps, such as one or more steps of a diffusion process performed by the diffusion model. In an embodiment, the estimated correspondence may be iteratively refined over a plurality of denoising steps. In this embodiment, each denoising step of the plurality of denoising steps may include processing a latent tensor computed at a previous denoising step and an estimated correspondence computed at the previous denoising step to generate a current latent tensor guided by the estimated correspondence computed at the previous denoising step and to generate a current self-attention map, and estimating a current correspondence based on the current self-attention map.

In an embodiment, the current self-attention map may be generated by merging aggregated attention maps generated at the current denoising step and each prior denoising step, where each of the aggregated attention maps is generated by summing averaged attention maps at a plurality of attention layers of the diffusion model. In an embodiment, the current latent tensor may be generated by optimizing the latent tensor computed at the previous denoising step based on an objective function. In an embodiment, the latent tensor computed at the previous denoising step may be optimized toward a direction where its attention maps are encouraged to adhere to the current self-attention map.

In a further embodiment, at each iteration postprocessing may be performed on the (current) estimated correspondence. In an embodiment, the postprocessing may include filtering the estimated correspondence. For example, the estimated correspondence may be filtered by excluding from the estimated correspondence reference tokens with more than a threshold number of corresponding target tokens. In an embodiment, the postprocessing may include smoothing the estimated correspondence. For example, the estimated correspondence may be smoothed using neighborhood weighted averages on the estimated correspondence.

In operation 104, the diffusion model is guided with the refined estimated correspondence as a constraint to inpaint the target image based on the reference image. The diffusion model may iteratively denoise the damaged region(s) of the target image, with guidance from the reference image based on the refined estimated correspondence between the reference image and the target image. For example, a region of the reference image that corresponds to a region of the target image to be inpainted may be determined from the refined estimated correspondence and then used to guide the diffusion model for inpainting the target image.

The inpainted target image generated by the diffusion model may include pixel (e.g. color) information for the (e.g. damaged) one or more regions of the input target image. In an embodiment, the inpainted target image may be output. In an embodiment, the inpainted target image may be output to a memory. In an embodiment, the inpainted target image may be output to a display device. In an embodiment, the inpainted target image may be output to a downstream application for further processing.

To this end, the method 100 provides inpainting of a target image by a diffusion model constrained by reference-target image correspondences. This correspondence constraint can preserve the reference-target geometric relationships during inpainting and thus enhance faithfulness of the inpainted target image to the reference image.

Further embodiments will now be provided in the description of the subsequent figures. It should be noted that the embodiments disclosed herein with reference to the method 100 of FIG. 1 may apply to and/or be used in combination with any of the embodiments of the remaining figures below.

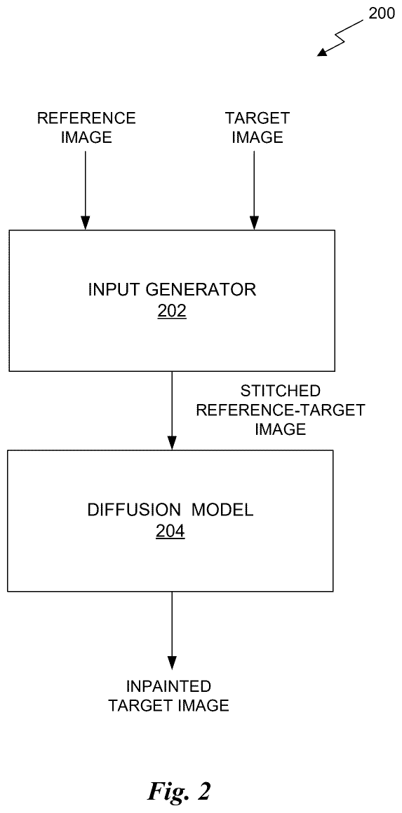

FIG. 2 illustrates a system 200 to provide reference-based inpainting for a target image, in accordance with an embodiment. The system 200 may be implemented to carry out the method 100 of FIG. 1, in an embodiment. Further, the descriptions and/or definitions given above may equally apply to the present embodiment.

As shown, the system 200 includes an input generator 202 that is configured to process an input target image to be inpainted and an input reference image to generate an input for a diffusion model 204. In an embodiment, the input generator 202 may stitch together (e.g. side-by-side) the target image and the reference image. In an embodiment, the resulting input for a diffusion model 204 may be a single image comprised of both the target image and the reference image.

The diffusion model 204 is configured to iteratively refine an estimated correspondence between the target image and the reference image to generate a refined estimated correspondence, and then to inpaint the target image based on the reference image with the refined estimated correspondence as a constraint guiding the inpainting process. The diffusion model 204 is further configured to output the inpainted target image.

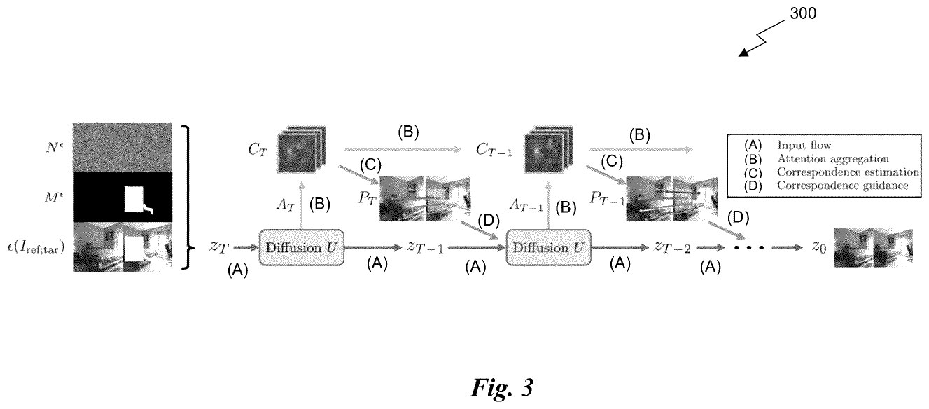

FIG. 3 illustrates a method 300 of the system 200 of FIG. 2, in accordance with an embodiment.

In the present embodiment, reference-based image inpainting involves a reference image I_{ref} ∈ [symbol] ^{h×w×3} and a target image Iₜₐᵣ ∈ [symbol] ^{h×w×3} with damaged regions indicated by a binary mask M∈{0, 1}^{h×w}. As depicted in FIG. 3, the method 300 aims to restore the damaged regions of Iₜₐᵣ by referring to I_{ref}.

For ease of cross-image attention, the reference and target images are horizontally stitched to yield I_{ref:tar} ∈ [symbol] ^{h×2w×3}. The system 200 includes a pre-trained latent diffusion model as the diffusion model 204, in the present embodiment. To work in the latent space, the stitched image is encoded into ϵ(I_{ref:tar})∈ [symbol] ^{h′×2w′×d}, where ϵ(⋅) is a variational autoencoder and d is the dimension of the latent space. The image latent ϵ( [symbol] ) is then concatenated with the noise latent N^{ϵ}∈ [symbol] ^{h′×2w′×d} and the resized input mask M^{ϵ}∈{0, 1}^{h′×2w′}, forming the input latent tensor z_{T} ∈ [symbol] ^{h′×2w′×(2d+1)} to the diffusion model 204.

For each denoising step t, it is carried out by a U-Net U network of the diffusion model 204, which takes the latent tensor zₜ and correspondence Pₜ₊₁ ∈[0, 1]^{h′×w′×2} computed in the previous step as input and produces zₜ₋₁ via noise estimation. To compute correspondence, the self-attention maps produced in the denoising process are used. During denoising, the self-attention map Aₜ ∈ [symbol] ^{(h′×2w′)×(h′×2′w)} is computed and represents the patch-wise similarity in the stitched image I_{ref:tar} at step t. A matching map Cₜ∈ [symbol] ^{h′×w′×h′×w′} is compiled to record the consensus on patch-wise similarities across the reference and target images of all attention maps. Namely, Cₜ (i, j, î, ĵ) denotes the matching degree between patch (i, j) in the target and patch (î, ĵ) in the reference. To aggregate information through the denoising process and stabilize the matching maps, Cₜ is estimated by considering both Cₜ₊₁ and Aₜ. The geometric constraints are further applied to Cₜ to construct correspondence Pₜ∈[0, 1]^{h′×w′×2}, where Pₜ(i, j) is the corresponding normalized coordinate in the reference of patch (i, j) in the target. The correspondence Pₜ serves as the input and can facilitate denoising and inpainting in the next step t-1.

With correspondence guidance, the diffusion model 204 can identify the most relevant parts to fill damaged regions, while avoiding interference from irrelevant parts. The present diffusion model 204 is configured to provide joint correspondence estimation and image inpainting, as described above. Self-attention scores are taken as similarity matrices so that these scores can serve as the common domain for both correspondence estimation and image inpainting.

The self-attention scores present the correlation between references and targets even in the early generation stages. However, the attention map from a single attention layer is often less informative. To address this, attention maps are aggregated through accumulation across different layers. Specifically, averaged attention maps at different layers are rescaled to a common size of (h′×2w′×h′×2w′) and sum them up, resulting in aggregated attention map Aₜ. Since correspondence is established across the reference and target images, we consider only the parts of self-attention scores where queries are from the target and key-value pairs are from the reference. Therefore, the target-to-reference attention map

$${A}_{t}^{tar 2 ref} ∈ {ℝ}^{{h}^{′} \times {w}^{′} \times {h}^{′} \times {w}^{′}} ,$$

a submatrix of Aₜ, is extracted accordingly.

To calculate correspondence, the matching map Cₜ is computed by merging all aggregated attention maps until the current timestep, per Equation 1.

$${C}_{t} = {\sum }_{τ = t}^{T} {A}_{τ}^{tar 2 ref} \qquad Equation 1$$

Calculating correspondences using consensus of the aggregated attention scores from multiple layers and timesteps eliminates the individual biases in certain layers and timesteps.

With the matching map Cₜ, the correspondence Pₜ (i, j) for target token (i, j) is presented as the corresponding reference token and is determined via Equation 2.

$${P}_{t} ( i , j ) = \begin{matrix}argmax \\ ( \hat{i} , \hat{j} )\end{matrix} {C}_{t} ( i , j , \hat{i} , \hat{j} ) \qquad Equation 2$$

where (i, j) and (î, ĵ) are the coordinates of the target and reference tokens, respectively.

### Embodiments of Correspondence Refinement

As the self-attention mechanism is essential to propagating reference content to the damaged regions in the target, target query tokens attending to irrelevant reference tokens typically lead to incorrect inpainting results. Since the preliminary correspondences Pₜ are established by referring to merely individual reference-target token pairs, they are not stable. Guiding the inpainting process solely on these correspondences fails to prevent the target tokens from attending to irrelevant tokens. To this end, a correspondence refining strategy may be employed, including filtering and smoothing, to eliminate the inaccurate correspondence in Pₜ.

Correspondence Filtering. Given that the effective correspondences only reside in the overlapping areas of the reference and target images, it is clear that not every target token has a corresponding reference token. For example, target tokens not located in the overlapping regions may tend to exhibit strong attention to certain reference tokens. These strongly attended but irrelevant reference tokens are referred to herein as dominant tokens. They need to be removed from correspondence constraints to avoid wrong feature propagation.

Dominant tokens are identified by the presence of strong attention from diverse target tokens in Pₜ. In an embodiment, reference tokens with more than a certain number of corresponding target tokens may be identified as dominant, where their associated correspondences are probably outliers and, therefore, are excluded from Pₜ. In one exemplary embodiment, the threshold may be set to four tokens. Additionally, some target tokens within the overlapping regions may also be affected by the dominant tokens, resulting in incorrect inpainting results. Hence, these excluded outlier correspondences are saved as Pₜ^{o}, which are used to mitigate the adverse effects they caused through guidance.

Correspondence Smoothing. A smoothing mechanism may be used, because in at least some instances when an incorrect inpainting result is present, a portion of target tokens at the center of the masked area (i.e., the damaged region) exhibit incorrect correspondences. Conversely, their surrounding tokens, located around the edges of the mask, may give more accurate correspondences and demonstrate attention scores consistent across different attention layers and timesteps. Therefore, neighborhood weighted averages can be employed for smoothing correspondence, which corrects misleading correspondence, aiming to alleviate the presence of unwanted objects and incorrect geometry.

To calculate neighborhood weighted averages on the correspondence, a displacement matrix Dₜ∈ [symbol] ^{h′×w′} is created, indicating the differences between each target token and its corresponding reference tokens in coordinate, i.e., Dₜ (i, j)=Pₜ (i, j)−(i, j). Next, the consensus matrix Wₜ∈ [symbol] ^{h′×w′} is constructed by assigning the matching score Cₜ (i, j, Pₜ (i, j)) to Wₜ (i, j) for target token (i, j), whose corresponding reference token is Pₜ (i, j). For outlier correspondences Pₜ^{o}, their consensus value is set to zero, and therefore they are ignored during the smoothing process. The neighborhood weighted average of Dₜ is then calculated using Wₜ as weights per Equation 3.

$${D}_{t}^{*} ( i , j ) = \frac{1}{\vert {W}_{t} ( i , j ) \vert} {\sum }_{( \hat{i} , \hat{j} ) ∈ N ( i , j )} {D}_{t} ( \hat{i} , \hat{j} ) \cdot {W}_{t} ( \hat{i} , \hat{j} ) \qquad Equation 3$$

where N (i, j) is the set of neighborhood tokens of token (i, j), and |Wₜ (i, j)|=Σ_{(î,ĵ)∈N(i,j)} Wₜ (î, ĵ). In this formulation, more accurate correspondences with higher degrees of consensus can be propagated to those tokens of incorrect correspondences in the form of displacements, and the smoothed displacements may then be converted back to correspondences through

$${P}_{t}^{*} ( i , j ) = {D}_{t}^{*} ( i , j ) + ( i , j ) .$$

The value of the smoothed correspondence Pₜ* is then assigned back to the original correspondence: Pₜ*→Pₜ.

### Embodiments of Cyclic Enhancement

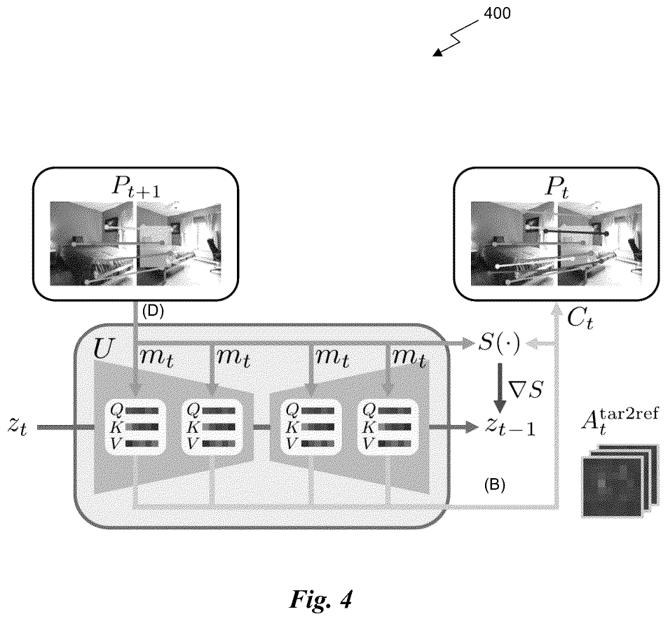

By applying correspondence constraints to the denoising process, the system 200 establishes a cyclic enhancement that jointly improves the correspondence and inpainting processes at each iteration, progressively guiding the generation toward a faithful result. FIG. 4 illustrates one cycle of the cyclic enhancement during a denoising step. Given the estimated correspondence Pₜ₊₁ from the previous step, the denoising process of the diffusion model 204 is guided by employing attention masks mt across all self-attention layers and further enhancing the input latent zₜ with an objective function S. The produced attention map

$${A}_{t}^{tar 2 ref}$$

is then used to enhance the estimated correspondence Pₜ₊₁ to Pₜ for the next step through updating the matching map Cₜ.

Attention Masking. To integrate correspondence constraints into the diffusion model 204, attention masks are employed within each self-attention layer. These attention masks are incorporated into the affinity matrix to modulate the influence of different value tokens.

The attention mechanism evaluates the contribution of value tokens through the affinity matrix, expressed as QK^{T}/\sqrt{dₐ}∈ [symbol] ^{(h′×2w′)×(h′×2w′)}, where Q and K are query and key token vectors, respectively, and dₙ is the embedding dimension. For ease of discussion, the present description focuses on operations conducted at a scale of ⅛, while these operations are consistent across all attention layers, regardless of scale. The attention mask mₜ ∈ [symbol] ^{(h′×2w′)×(h′×2w′)} adjusts the contribution of value tokens by adding either negative or positive values to the affinity matrix, resulting in the modified attentions: (QK^{T}+mₜ)/\sqrt{dₐ}∈ [symbol] ^{(h′×2w′)×(h′×2w′)}.

The attention mask is represented in the shape of h′×2w′×h′×2w′, which preserves the spatial context for both the queries and keys. A slice of the attention mask for a token (i, j) is defined as

$${m}_{t}^{ij} ∈ {ℝ}^{{h}^{′} \times 2 {w}^{′}} ,$$

denoting the part where the dot product between the query (i, j) and all keys occurs. The attention masks are composed according to the estimated correspondence Pₜ₊₁ from the previous denoising step. For a target token (i, j) whose correspondence is not an outlier, the element in the slice

$${m}_{t}^{ij}$$

is defined by Equation 4.

$${m}_{t}^{ij} ( \hat{i} , \hat{j} ) = \{ \begin{matrix}v , & if ( \hat{i} , \hat{j} ) ∈ N ( {P}_{t + 1} ( i , j ) ) , \\ - ∞ , & if ( \hat{i} , \hat{j} ) ∈ R - N ( {P}_{t + 1} ( i , j ) ) \\ 0 , & otherwise\end{matrix} \qquad Equation 4$$

where v represents a small positive number, N (Pₜ₊₁(i, j)) denotes the neighboring tokens of Pₜ₊₁(i, j), and R refers to the set of all reference tokens. When the attention mask is applied to a self-attention layer, this slice of the mask boosts the attention values of the corresponding areas, thereby promoting attention for the relevant tokens. Conversely, it diminishes the attention values for other reference tokens, preventing them from being attended to.

For outlier tokens in

$${P}_{t + 1}^{o} ,$$

the values assigned to their slices are defined per Equation 5.

$${m}_{t}^{ij} ( \hat{i} , \hat{j} ) = \{ \begin{matrix}- ∞ , & if ( \hat{i} , \hat{j} ) ∈ R ⋂ N ( {P}_{t + 1}^{o} ( i , j ) ) \\ 0 , & otherwise\end{matrix} \qquad Equation 5$$

This slice of the attention mask prevents the token (i, j) from attending to the irrelevant area, which is identified by the outlier correspondences. The remaining elements of the attention mask are assigned to 0, thereby preserving the original attention values for those tokens.

Latent Tensor Optimization. In an embodiment, solely employing attention masking may be insufficient for steering inpainting towards the desired outcomes. To address this issue, the produced constraints are used for further guidance by optimizing the latent tensor zₜ with an objective function S. The core concept is to optimize zₜ in a direction that aligns with the desired outcomes, specifically by ensuring that the attention of a token adheres to the pattern prescribed by Pₜ₊₁.

As depicted in FIG. 4, attention maps are collected from all self-attention layers within U. Similar to the process producing

$${A}_{t}^{tar 2 ref} ,$$

the attention maps are reshaped, resized, resulting in

$${( {A}_{1} )}_{t}^{tar 2 ref} ,$$

where l denotes the layer it is collected from. Instead of aggregating them, their gradients of the objective function S are calculated separately and the input latent zₜ is updated by gradient descent. The objective function S is defined per Equation 6.

$$S ( {( {A}_{1} )}_{t}^{tar 2 ref} ) = B C E ( Sigmoid ( Norm ( {( {A}_{1} )}_{t}^{tar 2 ref} ) ) , E ( {P}_{t + 1} ) ) \qquad Equation 6$$

where function Norm (⋅) normalize matrix

$${( {A}_{1} )}_{t}^{tar 2 ref} ,$$

and BCE(⋅) is uie weighted binary cross-entropy to [0, 1]. E(⋅) turns Pₜ₊₁ into a one-hot tensor of the same shape as

$${( {A}_{1} )}_{t}^{tar 2 ref} .$$

In this formulation, the input latent zₜ is optimized toward a direction where its attention maps are encouraged to adhere to the correspondence constraint.

To this end, the system 200 and related methods described herein provide a training-free module that incorporates correspondence constraints into reference-based image inpainting diffusion models. The system 200 achieves higher degrees of faithfulness to the reference images in the inpainting results by guiding the inpainting process with correspondence between the reference and target images. To perform this guidance, the capability of diffusion models to estimate correspondence during the inpainting process is exploited, and this correspondence can then be utilized to constrain the inpainting through self-attention masking and input latent optimization.

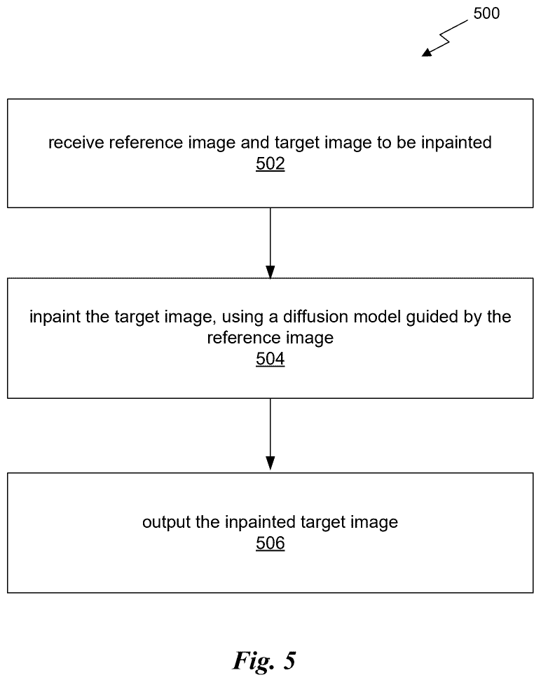

FIG. 5 illustrates an inpainting method 500, in accordance with an embodiment. In operation 502, a reference image and a target image to be inpainted are received. In an embodiment, the reference image and the target image may be received from a user input. In operation 504, the target image is inpainted, using a diffusion model guided by the reference image. In an embodiment, the inpainting may be performed by the system 200 of FIG. 2, as described above. In operation 506, the inpainted target image is output. For example, the inpainted target image may be output to a memory, a display device, and/or a downstream application.

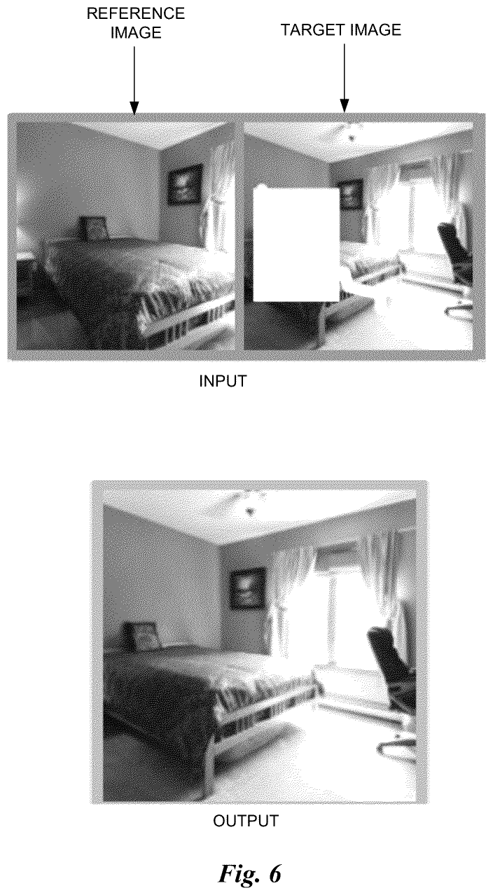

FIG. 6 illustrates an exemplary input and output of the inpainting method 500 of FIG. 5, in accordance with an embodiment. As shown, the input includes a reference image and a target image having a damaged region to be inpainted. The output includes the target image with the damaged region inpainted as guided by the reference image.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

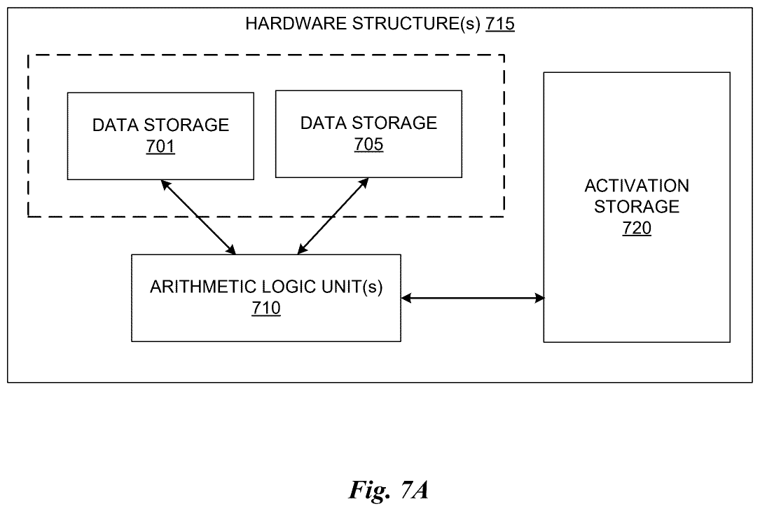

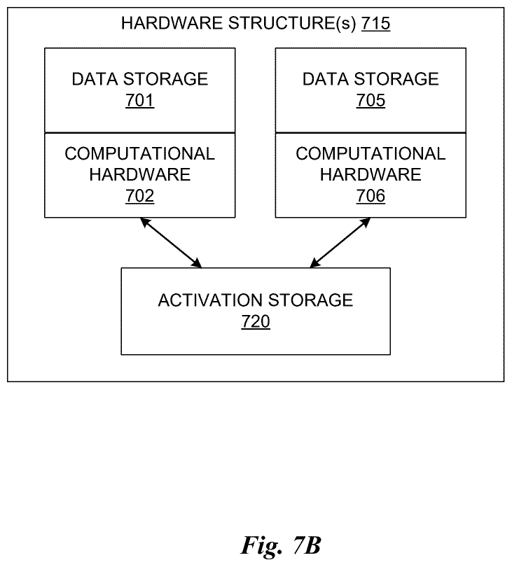

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

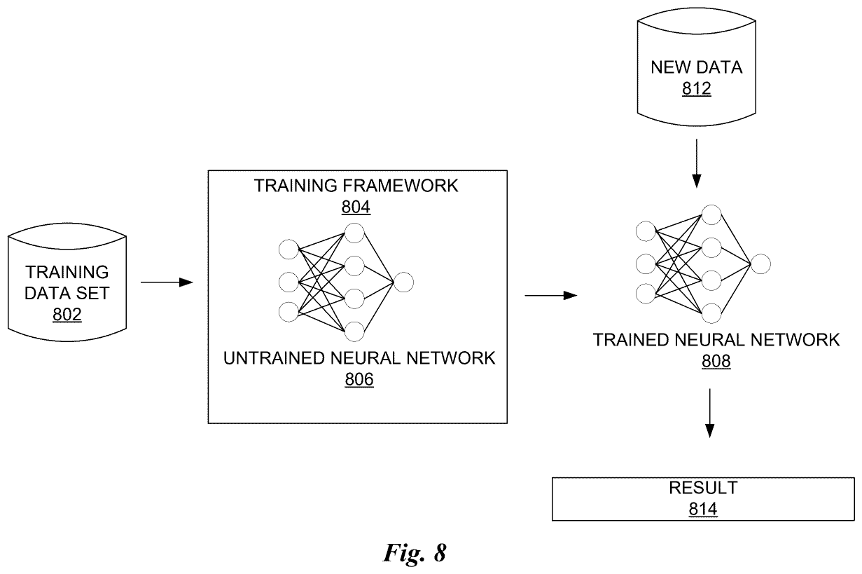

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

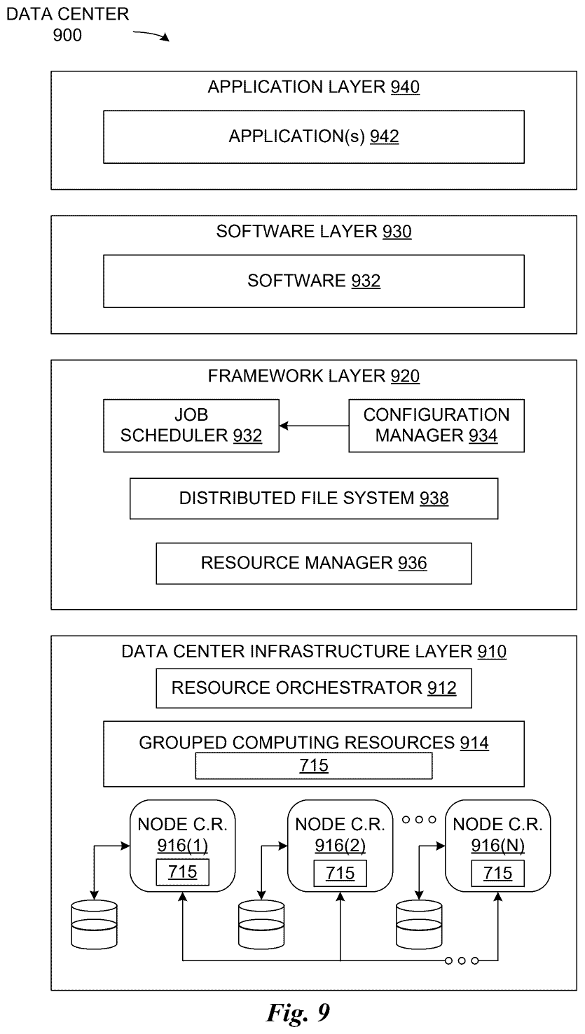

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide in painting of a target image using a diffusion model. In accordance with FIGS. 1-6, embodiments may provide a diffusion model usable for performing inferencing operations and for providing inferenced data. The diffusion model may be stored (partially or wholly) in one or both of data storage 701 and 705 in inference and/or training logic 715 as depicted in FIGS. 7A and 7B. Training and deployment of the diffusion model may be performed as depicted in FIG. 8 and described herein. Distribution of the diffusion model may be performed using one or more servers in a data center 900 as depicted in FIG. 9 and described herein.

What is claimed is:

1. A method, comprising:
at a device, performing reference-based inpainting for a target image by:
iteratively refining an estimated correspondence between the target image and a reference image, using a diffusion model, to generate a refined estimated correspondence; and
guiding the diffusion model with the refined estimated correspondence as a constraint to inpaint the target image based on the reference image.

2. The method of claim 1, wherein the target image includes at least one region to be inpainted.

3. The method of claim 2, wherein the at least one region is damaged.

4. The method of claim 1, wherein the target image and the reference image capture different viewpoints of a same scene.

5. The method of claim 1, wherein the iterative refining is initiated on an initial estimated correspondence.

6. The method of claim 5, wherein the initial estimated correspondence is generated by:
processing a latent tensor representative of the target image and the reference image, by the diffusion model, to generate an initial attention map, and
computing the initial estimated correspondence from the initial attention map.

7. The method of claim 6, wherein the latent tensor is generated by:
stitching together the reference image and the target image to form a stitched image,
encoding the stitched image to form an encoded stitched image,
encoding a mask of the stitched image to form an encoded mask,
encoding a noise tensor to form an encoded noise tensor,
concatenating the encoded stitched image, the encoded mask and the encoded noise tensor to form the latent tensor.

8. The method of claim 1, wherein the estimated correspondence is iteratively refined over a plurality of denoising steps, each denoising step of the plurality of denoising steps including:
processing, by the diffusion model, a latent tensor computed at a previous denoising step and an estimated correspondence computed at the previous denoising step to generate a current latent tensor guided by the estimated correspondence computed at the previous denoising step and to generate a current self-attention map, and
estimating a current correspondence based on the current self-attention map.

9. The method of claim 8, wherein the current self-attention map is generated by:
merging aggregated attention maps generated at the current denoising step and each prior denoising step,
wherein each of the aggregated attention maps is generated by summing averaged attention maps at a plurality of attention layers of the diffusion model.

10. The method of claim 8, wherein the current latent tensor is generated by optimizing the latent tensor computed at the previous denoising step based on an objective function.

11. The method of claim 10, wherein the latent tensor computed at the previous denoising step is optimized toward a direction where its attention maps are encouraged to adhere to the current self-attention map.

12. The method of claim 1, wherein the estimated correspondence maps coordinates in the reference image to coordinates in the target image.

13. The method of claim 1, wherein at each iteration postprocessing is performed on the estimated correspondence.

14. The method of claim 13, wherein the postprocessing includes filtering the estimated correspondence.

15. The method of claim 14, wherein the estimated correspondence is filtered by excluding from the estimated correspondence reference tokens with more than a threshold number of corresponding target tokens.

16. The method of claim 13, wherein the postprocessing includes smoothing the estimated correspondence.

17. The method of claim 16, wherein the estimated correspondence is smoothed using neighborhood weighted averages on the estimated correspondence.

18. The method of claim 1, further comprising, at the device:
outputting the inpainted target image.

19. A system, comprising:
a non-transitory memory comprising instructions; and
one or more processors in communication with the non-transitory memory, wherein the one or more processors execute the instructions to perform reference-based inpainting for a target image by:
iteratively refining an estimated correspondence between the target image and a reference image, using a diffusion model, to generate a refined estimated correspondence; and
guiding the diffusion model with the refined estimated correspondence as a constraint to inpaint the target image based on the reference image.

20. The system of claim 19, wherein the estimated correspondence is iteratively refined over a plurality of denoising steps, each denoising step of the plurality of denoising steps including:
processing, by the diffusion model, a latent tensor computed at a previous denoising step and an estimated correspondence computed at the previous denoising step to generate a current latent tensor guided by the estimated correspondence computed at the previous denoising step and to generate a current self-attention map, and
estimating a current correspondence based on the current self-attention map.

21. A non-transitory computer-readable media storing computer instructions which when executed by one or more processors of a device cause the device to perform reference-based inpainting for a target image by:
iteratively refining an estimated correspondence between the target image and a reference image, using a diffusion model, to generate a refined estimated correspondence; and
guiding the diffusion model with the refined estimated correspondence as a constraint to inpaint the target image based on the reference image.

22. The non-transitory computer-readable media of claim 21, wherein the estimated correspondence is iteratively refined over a plurality of denoising steps, each denoising step of the plurality of denoising steps including:
processing, by the diffusion model, a latent tensor computed at a previous denoising step and an estimated correspondence computed at the previous denoising step to generate a current latent tensor guided by the estimated correspondence computed at the previous denoising step and to generate a current self-attention map, and
estimating a current correspondence based on the current self-attention map.
